(19) United States
(12) Patent Application Publication
(10) Pub. No.: US 2005/0229777 A1
(43) Pub. Date: Oct. 20, 2005

(54) Method and apparatus for filtering particulate matter from an air-flow

(76) Inventors: Jeffrey A. Brown, Rockville, MD (US); Alexei Drozdov, Rockville, MD (US)

Correspondence Address: OLIFF & BERRIDGE, PLC, P.O. BOX 19928, ALEXANDRIA, VA, 22320, US

(21) Appl. No.: 10/825,664

(22) Filed: Apr. 16, 2004

(51) Int. Cl. B01D 46/46

(52) U.S. Cl. 95/1; 95/26; 96/417; 95/277; 55/400

(57) ABSTRACT

A method and apparatus is described for removing particles from an air-flow. An air-flow containing microscopic particulate matter is passed through a filter that rotates or oscillates at a high rate of speed relative to the speed of the air-flow and in a direction substantially perpendicular to the direction of the air-flow. The filter in motion impacts and thereby removes particulate matter from the air passing through it, yet the far smaller air molecules pass unimpeded through the mesh in the filter. The filter and filtration system maintain consistent operational performance despite changes in the condition of the filter and/or changes in the operational environment by adjusting the filter's speed and/or by cleaning the filter on a periodic or continuous basis. The effective life of a filter is extended, thereby increasing the period of time between filter replacements and reducing life-cycle man-power and material costs without any sacrifices in performance.

### BACKGROUND OF THE INVENTION

1. Field of the Invention

The present invention pertains to filtration. In particular, the present invention pertains to filtering particulate matter from an air-flow using a filter placed in motion.

2. Description of the Related Art

Particulate matter (PM) is the general term used for a mixture of solid particles and/or liquid droplets found in the air. These particles, which come in a wide range of sizes, may be emitted directly by a source or formed in the atmosphere. Particles suspended within the air in domestic, commercial and industrial environments typically range in size from less than 0.01 μm (e.g., smokes) to as high as 45 μm (e.g., dust, pollen spores, emissions from industrial processes, etc). Table 1, below, presents a representative distribution of particle sizes that may be suspended within the atmosphere in a domestic, commercial or industrial environment. In addition to the particle sizes listed in Table 1, even larger particles may remain suspended for prolonged periods of time, riding upon individual currents of rising, falling and/or swirling air, before finally settling out of the atmosphere.

TABLE 1
Representative Particulate Distribution in an Atmosphere

| Percent* | Particle | Average, |
|---|---|---|
| by vol | size, μm | μm |
| 28 | 10-45 | 20 |
| 52 | 5-10 | 7½ |
| 11 | 3-5 | 4 |
| 6 | 1-3 | 2 |
| 2 | 1-1½ | ¾ |
| 1 | 0-½ | ¼ |

*85 percent of viscous particles tend to be in the highest range of sizes.

Conventional filters used to filter a flow of air, or air-flow, are available in a wide variety of designs to meet a wide range of consumer, commercial and industrial air-cleaning requirements. Selection of a filter for a specific application may be based upon considerations that include the volume of air to be filtered per unit of time, the expected concentration of particles within the air-flow to be filtered, expected particle sizes, characteristics of the particles to be removed, the level of purity required in the filtered air, initial costs and life-cycle maintenance costs.

Physical filters are commonly characterized as viscous impingement filters, dry filters and High-Efficiency Particulate Air (HEPA) filters. Both viscous impingement and dry-type filters may be constructed from cellulose fibers, banded fiberglass, wool felt, synthetics, and similar fibers. Viscous impingement filters are typically a coarsely woven, viscous-coated mesh, against which dust particles impinge and are held by the viscous surface. Dry-type filters are typically constructed of finely woven fabric-like or blanket-like materials of varying thickness within which air-born particles become physically trapped. High-Efficiency Particulate Air (HEPA) filters are usually constructed of a fabric of fine fibers, such as fiberglass, applied to a separating medium, usually paper, in a zig-zag pattern so as to produce a deep, multi-layered design.

Filters and filtering technologies may be characterized based upon a number of performance characteristics, such as: the smallest particle size the filter is designed to trap; the expected concentration of particles per volume of filtered air; the velocity of the air-flow the filter is designed to handle, or face velocity, typically measured in feet per minute; a resistance to air-flow a clean filter introduces at the recommended face velocity; and, an efficiency rating, which typically characterizes the effectiveness of the filter in capturing the smallest sized particles that the filter is designed to trap. Table 2 presents performance characteristics for five representative conventional filters: a disposable viscous impingement filter; a washable viscous impingement filter; a large particle dry filter; a small particle dry filter; and, a HEPA paper filter.

TABLE 2
Representative Filter Technology Characteristics

| Filter Description | | | Optimum | | | Usual | |
|---|---|---|---|---|---|---|---|
| General | Specific | | Part. size, | Concentration, | Usual Face | Clean Pressure | Efficiency, % |
| Class | type | Removes | μm | grains/cu ft | Velocity, fpm | Drop in. W.G. | by wt |
| Viscous | Throwaway | Lints, | >5 μm | <0.002 | 300-500 | <0.1 | <25 |
| Impingement | Washable | dusts, | | | | | |
| Filters | | pollens | | | | | |
| Dry Filters | 5-10 μm | | >3 μm | <0.001 | 5-25 | <0.3 | >50 |
| (large pore) | | | | | | | |
| Dry filters | 2-5 μm | | >0.5 μm | <0.001 | 5-25 | <0.5 | <95 |
| (small pore) | | | | | | | |
| HEPA filter | Paper | Smoke, | >0.3 μm | <0.001 | 4-6 | <1 | >99.95 |
| | | Bacteria | | | | | |

Each filter represented in Table 2 is designed to meet different filtering needs. As indicated in Table 2, viscous impingement filters typically offer low air-flow resistance and may be used to filter air-flows with relatively high velocities (e.g., approximately 300-500 fpm). Typically, however, viscous impingement filters only trap larger particles (e.g., greater than 5 μm) and do so with less efficiency (e.g., typically trapping less then 25%, by weight, of particles greater than 5 μm in diameter) than can be achieved using dry or HEPA filters. HEPA and dry filters are capable of trapping smaller particles (e.g. as small as 0.3 μm) with higher efficiency (e.g., typically trapping up to 99.5% by weight of particles with a diameter of 0.3 μm or greater), but such efficiency is achieved at the cost of a greater resistance to air-flow and an inability to support high air-flow face velocities. As a result, the volume of air that can be filtered per unit of time with a dry or HEPA filter is significantly less than the volume of air that can be filtered by a viscous impingement filter with the same surface area during the same amount of time.

Conventional physical filters are typically configured with a fixed mesh size, or a fixed pore size, that is designed to trap particles above a predetermined size. Once a conventional filter is constructed, the mesh and/or pore characteristics of the filter cannot be adjusted to accommodate changes in the condition of the filter (e.g., a buildup of particles upon the filter, an increase in the pressure drop across the filter in response to a filtered air-flow velocity) and/or changes in the operational environment (e.g., changes in the velocity/pressure of the filtered air-flow, changes in the size/density of particles within the air stream).

In conventional filters, to trap small particles with high degree of probability, a filter with a correspondingly small average pore size is typically used. However, the smaller the pore size of conventional filters, the greater the resistance to air-flow (i.e., the greater the pressure drop) typically introduced by a clean conventional filter to a stream of air flowing through the filter. In addition, the smaller the average pore size of a conventional filter, the fewer the number of filtered particles that are needed to buildup and to clog individual pores of the filter. Hence, filters designed to capture smaller particles with a high degree efficiency are typically more susceptible to becoming clogged with particles filtered from the air-flow, thereby reducing air-flow through the filter and, hence, reducing the effectiveness of the filter in removing particles from the air-flow.

Conventional filters are typically stationary during operation. A conventional filter is typically placed within a channel, or duct, through which the air-flow to be filtered is directed. Particles typically stick to a conventional filter as a result of becoming entrapped within the filter material, and/or sticking to the filter upon impact. Any force with which a particle strikes a conventional filter is the result of a kinetic energy imparted to the particle by the air-flow within which the particle is suspended.

A filter gauge may be installed across a filter to monitor the pressure drop across a filter. Such a gauge typically quantifies a drop in pressure across a filter in terms of inches of water column (W.C.). The pressure drop observed across a clean filter in response to a face velocity that the filter is designed to support is called the clean pressure drop, as indicated in Table 2. Due to the clean pressure drop associated with conventional filters, in order for an air-flow through a conventional filter to occur, an air-flow within a channel prior to the filter must have sufficient pressure to overcome the clean pressure drop across the filter, otherwise no flow through the filter will occur and no particles will be filtered from the air. As conventional filters begin to collect particulate matter from the air they are filtering, their effectiveness immediately begins to decline. A buildup of trapped particles within the filter increases the resistance of the filter to the incoming air-flow and reduces the amount of air circulated by the ventilation system. Inadequate air-flow means a lesser volume of filtered air to dilute objectionable air-born particles within a filtered environment, and less return air to the filter, thereby reducing the rate at which additional air-born particles can be removed. The rate at which a filter loads up depends on the efficiency of the filter, the quantity and size of particles per unit of air, and the volume of air that passes through the filter.

As a filter loads up with trapped particles, the pressure drop across the filter typically increases as the passages, or pores, through the filter are reduced in size and/or become constricted. Typically a filter is replaced when the pressure drop increases by a predetermined value (e.g. about 0.2″ W.C.). This is called the change-out pressure. In systems not equipped with a filter gauge, the filters are typically inspected and/or cleaned or replaced in accordance with a periodic-maintenance schedule.

Hence, a need remains for an apparatus and method capable of removing a broad range of particle sizes from an air-flow, yet that produces a low resistance to air-flow even when filtering air-flows with high velocities. Preferably, the effectiveness of such an air-flow filtering approach would not diminish, and resistance to air-flow would not increase, as the filter becomes loaded with particles captured from a filtered air-flow. Further, the approach would preferably be manually or dynamically configurable to meet a predetermined or dynamically configurable set of performance criteria. In addition, the approach would preferably be self-cleaning and/or require minimal maintenance and upkeep, thereby extending periods between scheduled maintenance and/or filter replacement.

### OBJECTS AND SUMMARY OF THE INVENTION

Therefore, in light of the above, and for other reasons that may become apparent when the invention is fully described, an object of the present invention is to reduce filter back-pressure associated with filtering small particles from an air-flow.

Another object of the present invention is to maintain reduced filter back-pressure despite loading of a filter with trapped particles.

Yet another object of the present invention is to maintain reduced filter back-pressure despite increases in air-flow velocities.

Still another object of the present invention is to maintain filter efficiency despite loading of a filter with trapped particles.

A further object of the present invention is to increase filter life while maintaining consistent operational performance.

A still further object of the present invention is to maintain consistent filter operational performance despite dynamically changing operational conditions.

The aforesaid objects are achieved individually and in combination, and it is not intended that the present invention be construed as requiring two or more of the objects to be combined unless expressly required by the claims attached hereto.

A method and apparatus is described for filtering particles from an air-flow with a filter that is placed in motion. In accordance with the present invention, any air containing macroscopic and/or microscopic particulate matter may be passed through a filter that is placed in motion at a high rate of speed relative to the speed of the air-flow and in a direction substantially perpendicular to that of the air-flow. The filter intercepts, or impacts, particulate matter within the air-flow passing through the filter, yet the far smaller air molecules pass through the filter unimpeded.

The present invention allows a filter with a relatively large mesh, or pore size, to filter particles much smaller than the filter could otherwise remove if the filter were to remain stationary. By adjusting the speed at which the filter of the present invention is placed in motion through the air-flow to be filtered, a virtual pore size may be achieved that may be much smaller than the physical mesh, or pore size, of the filter. Based upon the physical mesh/pore size of the filter and the velocity of the air-flow to be filtered, the speed of the filter may be adjusted to filter virtually any minimum size particle to virtually any desired level of efficiency. Upon impact by the filter, particulate matter within a filtered air-flow may adhere to the filter material, become physically trapped by the filter material and/or be blocked or deflected from the air-flow in a manner that facilitates collection and disposal of the blocked and/or deflected particles.

Despite movement of the filter within the air-flow to achieve a small virtual mesh/pore size capable of efficiently filtering microscopic particles of a selected minimum diameter, the filter of the present invention produces far less back-pressure than would be produced by a conventional filter capable of filtering the same minimum diameter particles from the same air-flow with the same level of efficiency. The reduced back-pressure generated may be attributed to the larger physical size of the mesh/pores of the filter. Despite the filter being placed in motion, the open surface area in the filter through which the air-flow may pass remains greater than that of a conventional stationary filter configured to trap particles of the same size with equal efficiency. Therefore, in comparison to a conventional filter, a relative decrease in filter back-pressure is achieved. This relative decrease in back-pressure over conventional filters is maintained even as air-flow velocities are increased.

The relative reduction in back-pressure achieved with the filter of the present invention over conventional filters capable of trapping particles of the same size with equal efficiency from an air-flow with equal velocity is maintained despite loading of the filter of the present invention with trapped particles. In fact, assuming that a conventional filter and the filter of the present invention have trapped an equal mass of particles, the back-pressure created by the conventional filter will increase at a faster rate than the filter of the present invention. This is because the filter of the present invention retains more open surface area through which the air-flow may pass than a conventional stationary filter will retain for the same amount of trapped particulate matter. Further, in embodiments of the present invention that support dynamic feedback control, the speed of the filter may be adjusted (i.e., increased or decreased) in order to maintain a constant back-pressure and/or a constant minimum particle size tolerance in view of the particle loading.

By adjusting the speed of a filter in accordance with the present invention, a filter that is partially loaded with particles may continue to trap small particles with the same efficiency that the filter was able to capture when clean. Due to the decreased physical mesh/pore size, the loaded filter of the present invention will retain the same virtual mesh/pore size at the reduced speed. In this manner, the efficiency and back-pressure in the filter of the present invention may be retained despite particle loading, whereas back-pressure would increase in a particle loaded conventional filter, resulting in decreased efficiency due to reduce air-flow through the filter.

A filter of the present invention used within a manually and/or dynamically adjustable filtration system, in accordance with the present invention, is able to maintain consistent operational performance despite changes in the condition of the filter and/or changes in the operational environment. In this manner the effective life of a filter is extended, thereby increasing the period of time between filter replacements and reducing life-cycle man-power and material costs without any sacrifice in performance. Further, embodiments of the filter and filtration system of the present invention may support self-cleaning methods and techniques that virtually eliminate degradation in filter performance, filter replacement and filter maintenance related to particle buildup upon the filter.

In one exemplary embodiment, the filter of the present invention is in the shape of a cylinder. The cylinder may be rotated about a central axis of the cylinder that is aligned substantially perpendicular to the direction of the filtered air-flow. In another exemplary embodiment, the filter of the present invention is planar. The planar filter may be rotated about a central axis of the plane so that the planar filter rotates in a plane substantially perpendicular to the direction of the filtered air-flow. In yet another exemplary embodiment, the shape of the filter remains planar, but the planar filter is moved in a reciprocating motion in a plane that is substantially perpendicular to the direction of the filtered air-flow. In still yet another embodiment, the filter may be a screen in the shape of a continuous loop or belt that is placed in circular motion so that the filter may pass continuously through a filtered air-flow at an angle that is substantially perpendicular to the direction of the filtered air-flow. Such filter shapes are exemplary only. The filter of the present invention is not limited to any specific shape, size or type of motion. The present invention may include any filter placed in motion at a high rate of speed relative to the speed of the air-flow to be filtered. Preferably, the filter and the direction of motion of the filter is oriented substantially perpendicular to the filtered air-flow.

A filter of the present invention may be of any size and shape and may be placed directly within an existing duct or placed within a filter housing suitable for the filter type, filter size, filter shape, type of filter motion and/or type of self-cleaning technique employed by the filtration system in which the filter is used. Use of a filter housing allows the filtration system of the present invention to be adapted for stand-alone use and/or for use with existing ductwork of any size and shape.

As conventional physical filters begin to collect particulate matter from a filtered air-flow, the effectiveness of the conventional filters begins to decline. The collected particulate matter begins to clog the physical filter, thereby increasing filter back-pressure and decreasing air-flow through the filter. Unlike these conventional filters, the filter and filtration system of the present invention actually gains effectiveness during the initial period of its use. The increased filter surface area and increased adhesiveness produced by sticky particles collecting on the filter increases the effectiveness of the filter. The low concentration of filter fibers relative to the open space between filter fibers and the large distance between the filter fibers relative to the size of the air molecules, allows air-flow to be virtually unimpeded by the filter and to remain unimpeded far longer than with traditional physical filters. The higher the coefficient of filter speed to air speed, the more effective the cleaning.

The above and still further objects, features and advantages of the present invention will become apparent upon consideration of the following detailed description of specific embodiments thereof, particularly when taken in conjunction with the accompanying drawings wherein like reference numerals in the various figures are utilized to designate like components.

### BRIEF DESCRIPTION OF THE DRAWINGS

FIG. 1A is a diagrammatic view of a cylindrical bar filter that rotates within a duct, or housing, substantially perpendicular to the filtered air-flow in accordance with an exemplary embodiment of the present invention.

FIG. 1B is a diagrammatic view of a cylindrical mesh filter that rotates within a duct, or housing, substantially perpendicular to the filtered air-flow in accordance with an exemplary embodiment of the present invention.

FIG. 2A is a diagrammatic view of a planar spoked filter that rotates within a duct, or housing, substantially perpendicular to the filtered air-flow in accordance with an exemplary embodiment of the present invention.

FIG. 2B is a diagrammatic view of a planar mesh filter that rotates within a duct, or housing, substantially perpendicular to the filtered air-flow in accordance with an exemplary embodiment of the present invention.

FIG. 3A is a diagrammatic view of a planar bar filter that reciprocates within a duct, or housing, substantially perpendicular to the filtered air-flow in accordance with an exemplary embodiment of the present invention.

FIG. 3B is a diagrammatic view of a planar mesh filter that reciprocates within a duct, or housing, substantially perpendicular to the filtered air-flow in accordance with an exemplary embodiment of the present invention.

FIG. 4 is a block diagram of a filtration system with optional dynamic controls in accordance with an exemplary embodiment of the present invention.

FIG. 5 is a process flow diagram that describes operation of a filtration system with optional dynamic controls in accordance with an exemplary embodiment of the present invention.

### DETAILED DESCRIPTION OF THE PREFERRED EMBODIMENTS

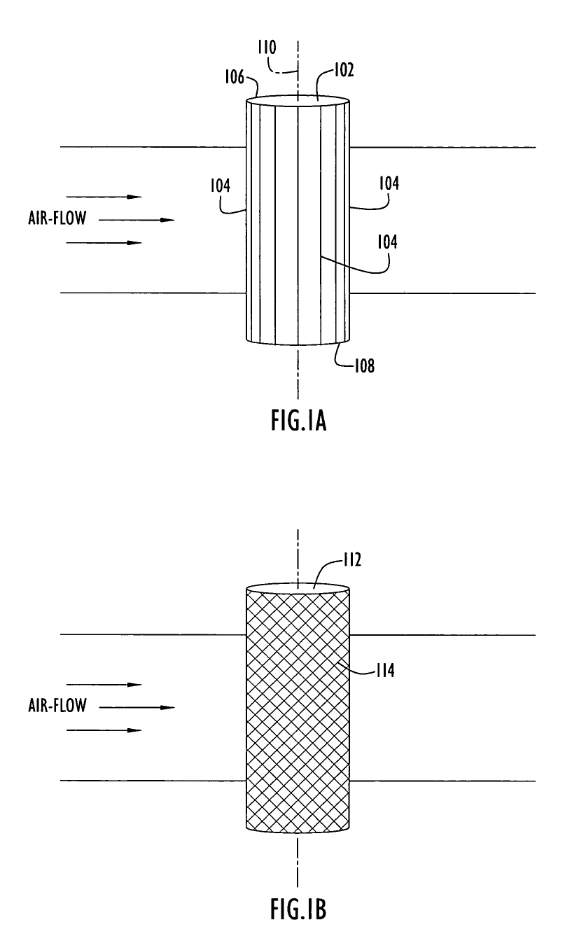

FIG. 1A and FIG. 1B are diagrammatic views of a cylindrical bar filter and a cylindrical mesh filter, respectively, that may be used to filter air flowing within a channel, or duct. In such an embodiment, the filter is in the shape of a substantially hollow right cylinder with a diameter (D) and a cylinder height (H). As shown in FIG. 1A, cylindrical bar filter 102 may include a set of parallel bars 104 that connect points on the perimeter of circular base 106 with corresponding points upon circular base 108, thereby forming a right cylinder balanced about a central axis 110. Cylindrical bar filter 102 may be inserted directly within a rectangular air channel, or duct, with a length (L) that is only slightly greater (e.g., 0.5 cm) than cylinder height (H), and a width (W) that is only slightly greater (e.g., 0.5 cm) than the diameter (D) of cylindrical bar filter 102. Optionally, cylindrical bar filter 102 may be housed within a separate housing that may be connected within the air-flow of an existing air channel, or duct, of any size or shape using adapting couplers. In either embodiment, cylindrical bar filter 102 rotates freely about axis 110 within a duct, or housing, substantially perpendicular to the filtered air-flow.

In accordance with the present invention, cylindrical bar filter 102 is rotated about axis 110 at a high rate of speed relative to the speed of the filtered air-flow. Parallel bars 104 of cylindrical bar filter 102 impact particulate matter within the air-flow passing through cylindrical bar filter 102, yet the far smaller air molecules pass through cylindrical bar filter 102 unimpeded. Upon impact by the filter, particles within a filtered air-flow may adhere to the filter material, become physically trapped by the filter material and/or be blocked or deflected by the filter into a collection bin, or collection chute, that may be integrated within the filter duct, or filter housing, to receive and collect blocked and/or deflected particles.

As shown in FIG. 1B, cylindrical mesh filter 112 is similar to cylindrical bar filter 102, with the exception that the set of parallel perimeter bars 104 is covered by, or replaced with, mesh 114. In one embodiment, mesh 114 may be wrapped around parallel perimeter bars 104 of a cylindrical bar filter 102 and may be fastened to parallel perimeter bars 104, circular base 106 and circular base 108 to create cylindrical mesh filter 112. In another embodiment, mesh 114 is in the form of a tube that is slid over a cylindrical frame such as cylindrical bar filter 102. In yet another embodiment, mesh 114 may be attached to the perimeter of circular base 106 and the perimeter of circular base 108 without use of a set of parallel perimeter bars to form cylindrical mesh filter 112.

In accordance with the present invention, cylindrical mesh filter 112 is rotated about axis 110 at a high rate of speed relative to the speed of the filtered air-flow. Mesh 114 of cylindrical mesh filter 112 impacts particulate matter within the air-flow passing through cylindrical mesh filter 112, yet the far smaller air molecules pass through cylindrical mesh filter 112 unimpeded. Upon impact by the filter, particles within a filtered air-flow may adhere to the filter material, become physically trapped by the filter material and/or be blocked or deflected by the filter into a collection bin, or collection chute, that may be integrated within the filter duct, or filter housing, to receive and collect blocked and/or deflected particles.

Preferably, in both embodiments, the resulting cylindrical filter is substantially rigid and capable of being rotated about axis 110 by a single drive module connected to an end of the cylinder. For example, in one embodiment, circular base 106 and circular base 108 may be substantially solid, rigid disks, connected to one another along central axis 110 by a rigid shaft. In such an embodiment perimeter bars 104 and/or mesh 114 need not provide structural support in order for the filter to maintain a cylindrical shape during rotation, as described above. In another embodiment, circular base 106 and circular base 108 may each include a substantially rigid outer periphery connected to a central hub via spokes, thereby allowing circular base 106 and circular base 108 to be connected to one another along central axis 110 by rigid shaft that passes through and attaches to each circular base at a central hub. In such an embodiment perimeter bars 104 and/or mesh 114 may also be non-structural. In yet another embodiment, circular base 106 and circular base 108 include a substantially rigid outer periphery, only. In such an embodiment parallel perimeter bars 104 and/or mesh 114 provide the structural support required to hold the cylindrical filter rigid. In still yet another embodiment, circular base 106 and circular base 108 include substantially rigid solid disks, but the disks are not held together by a central shaft. Instead, parallel perimeter bars 104 and/or mesh 114 provide the structural support to connect circular base 106 to circular base 108 and to hold the cylindrical filter rigid. In such an embodiment, circular base 106 and circular base 108 preferably include protruding central hubs that allow the cylinder to be rotated about central axis 110.

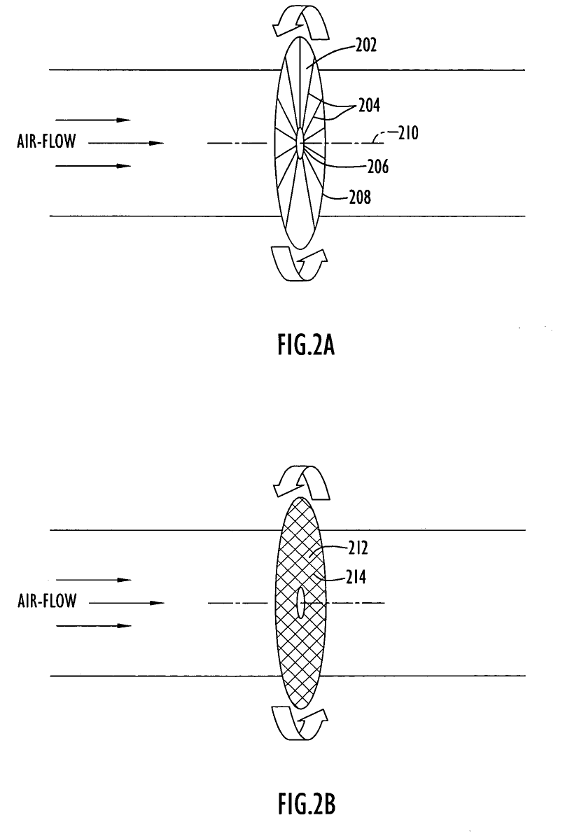

FIG. 2A and FIG. 2B are diagrammatic views of a rotating plane spoke filter and a rotating plane mesh filter, respectively, that may be used to filter any air-flow within an air channel, or duct. The rotating plane filters presented in FIG. 2A and FIG. 2B are exemplary embodiments only. Rotating plane filters may be of any size or shape, but share a common characteristic in that each filter is rotated in a plane substantially perpendicular to the filtered air-flow.

For example, as shown in FIG. 2A, a rotating plane filter may be in the shape of a substantially flat circular disk with a diameter (D). As depicted in FIG. 2A, a circular rotating plane filter 202 may include a set of spokes 204 radiating from a central hub 206 to a circular edge perimeter 208. Such a circular rotating plane spoke filter 202 may be inserted within a round tubular air channel, or duct, with a diameter that is only slightly greater (e.g., 0.5 cm) than the diameter of circular rotating plane spoke filter 202. In this manner, circular rotating plane filter 202 substantially fills a cross-section of the tubular duct. Positioning circular rotating plane filter 202 within a round tubular duct in such a manner allows the filter to rotate freely about axis 210 within the duct substantially perpendicular to the air-flow through the duct.

Optionally, rotating plane spoke filter 202 may be housed within a separate housing that may be connected within the air-flow of an existing air channel, or duct, of any size or shape using adapting couplers. In such an externally housed embodiment, rotating plane spoke filter 202 may be of any size and shape. For example, in one exemplary embodiment, rotating plane spoke filter 202 rotates about an axis 210 that is parallel but external to the filtered airflow. In such an embodiment, only a portion of rotating plane spoke filter 202 passes through the filtered airflow at any given point in time, thereby allowing the filtration system with an opportunity to remove collected particles from portions of rotating plane spoke filter 202 that are not actively within the filtered airflow.

In accordance with the present invention, rotating plane spoke filter 202 is rotated about axis 210 at a high rate of speed relative to the speed of the filtered air-flow. Spokes 204 of rotating plane spoke filter 202 impact particulate matter within the air-flow passing through rotating plane spoke filter 202, yet the far smaller air molecules pass unimpeded through rotating plane spoke filter 202. Upon impact by the filter, particles within a filtered air-flow may adhere to the filter material, become physically trapped by the filter material and/or be blocked or deflected by the filter into a collection bin, or collection chute, that may be integrated within the filter duct, or filter housing, to receive and collect blocked and/or deflected particles.

As shown in FIG. 2B, rotating plane mesh filter 212 is similar to circular disk spoke filter 202, with the exception that the set of spokes 204 is covered by, or replaced with, mesh 214. In one embodiment, mesh 214 may be fastened at central hub 206 and/or fastened to spokes 204 and/or fastened to a circular edge perimeter 208. In another embodiment, mesh 214 may be fastened at central hub 206, only. Preferably, in both embodiments, the resulting rotating plane filter is substantially rigid and capable of being rotated about axis 210 by a single drive module connected to central hub 206.

In accordance with the present invention, rotating plane mesh filter 212 is rotated about axis 210 at a high rate of speed relative to the speed of the filtered air-flow. Mesh 214 of rotating plane mesh filter 212 impacts particulate matter within the air-flow passing through rotating plane mesh filter 212, yet the far smaller air molecules pass unimpeded through rotating plane mesh filter 212. Upon impact by the filter, particles within a filtered air-flow may adhere to the filter material, become physically trapped by the filter material and/or be blocked or deflected by the filter into a collection bin, or collection chute, that may be integrated within the filter duct, or filter housing, to receive and collect blocked and/or deflected particles.

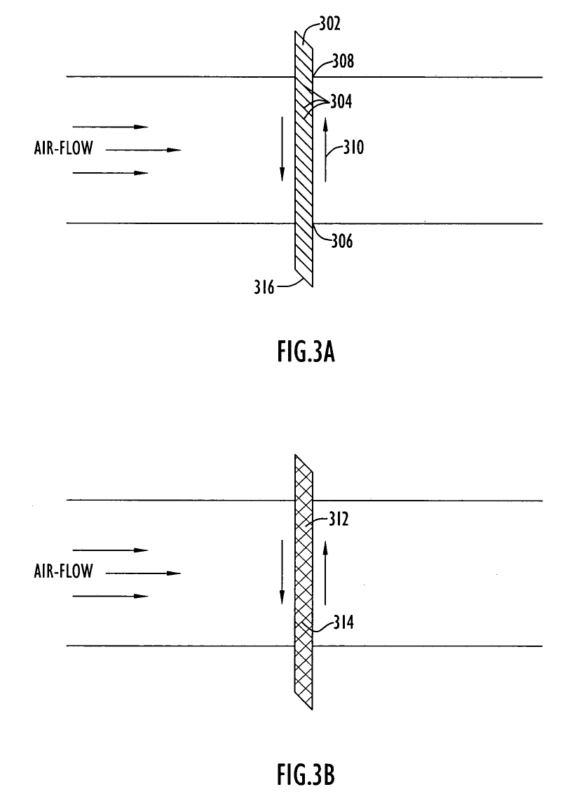

FIG. 3A and FIG. 3B are diagrammatic views of a planar reciprocating bar filter and a planar reciprocating mesh filter, respectively, that may be used to filter any air-flow within a channel, or duct.

As shown in FIG. 3A, reciprocating bar filter 302 may include a set of bars 304 arranged perpendicularly to a reciprocating, or oscillating, motion 310 that moves reciprocating bar filter 302 in a plane perpendicular to air flowing within the duct. In one embodiment, reciprocating bar filter 302 may be inserted through an upper slot (308) and lower slot (306) in an air channel, or duct, with a rectangular cross-section that is only slightly greater (e.g., 0.5 cm) in width than a corresponding width of reciprocating bar filter 302 and with a height that is significantly less (e.g., 1 inch) than the height of reciprocating bar filter 302. In such an embodiment, reciprocating bar filter 302 may protrude through slots in the upper and lower faces of the rectangular duct so that filter bars 304 are oriented perpendicular to reciprocating motion 310 and the filter is oriented perpendicular to the filtered air-flow. Such a configuration allows reciprocating bar filter 302 to reciprocate within a plane perpendicular to the air flowing through the duct, while the upper and lower opposing slots act as guides that hold the reciprocating filter in place. Optionally, reciprocating bar filter 302 may be housed within a separate housing that may be connected within the air-flow of an existing air channel, or duct, of any size or shape using adapting couplers. In either embodiment, reciprocating bar filter 302 reciprocates in the direction of reciprocating motion 310 within a duct or housing, substantially perpendicular to the filtered air-flow.

In accordance with the present invention, reciprocating bar filter 302 is reciprocated, or oscillated, at a high rate of speed relative to the speed of the air-flow passing through the duct, or housing, in a plane substantially perpendicular to the air-flow. The bars 304 of reciprocating bar filter 302 impact particulate matter within the air-flow passing through reciprocating bar filter 302, yet the far smaller air molecules pass unimpeded through reciprocating bar filter 302 in the filter. Upon impact by the filter, particles within a filtered air-flow may adhere to the filter material, become physically trapped by the filter material and/or be blocked or deflected by the filter into a collection bin, or collection chute, that may be integrated within the filter duct, or filter housing, to receive and collect blocked and/or deflected particles.

As shown in FIG. 3B, reciprocating mesh filter 312 is similar to reciprocating bar filter 302, with the exception that the set of bars 304 is covered by, or replaced with, mesh 314. In one embodiment, mesh 314 may be fastened to bars 304. Preferably, in both reciprocating filter embodiments, the resulting reciprocating filter is substantially rigid and capable of being reciprocated in a plane substantially perpendicular to the air-flow through the duct, or housing, by a single reciprocating drive module connected to a protruding edge 316.

In accordance with the present invention, reciprocating mesh filter 312 is reciprocated at a high rate of speed relative to the speed of the air-flow passing through the duct, or housing, in a plane substantially perpendicular to the air-flow. Mesh 314 of reciprocating mesh filter 312 impacts particulate matter within the air-flow passing through reciprocating mesh filter 312, yet the far smaller air molecules pass unimpeded through reciprocating mesh filter 312 in the filter. Upon impact by the filter, particles within a filtered air-flow may adhere to the filter material, become physically trapped by the filter material and/or be blocked or deflected by the filter into a collection bin, or collection chute, that may be integrated within the filter duct, or filter housing, to receive and collect blocked and/or deflected particles.

The filter embodiments and types of motion described above are exemplary, only. A filter in accordance with the present invention is not limited to any specific shape, size or type of motion. The present invention may include any filter placed in motion at a high rate of speed relative to the speed of the air-flow to be filtered. For example, in yet another exemplary embodiment of the present invention, the filter may be a screen in the shape of a continuous loop or belt that is placed in circular motion so that the filter may pass continuously through a filtered air-flow at a high rate of speed relative to the air-flow, at an angle that is substantially perpendicular to the air-flow. Such an embodiment allows the filter to trap particles from the air-flow as the filter passes through the air-flow and allows the filter to be cleaned of particles upon exiting the filtered air-flow, possibly by passing the belt filter through a stream of compressed air, thereby allowing trapped particles to be removed prior to the filter re-entering the filtered air-flow.

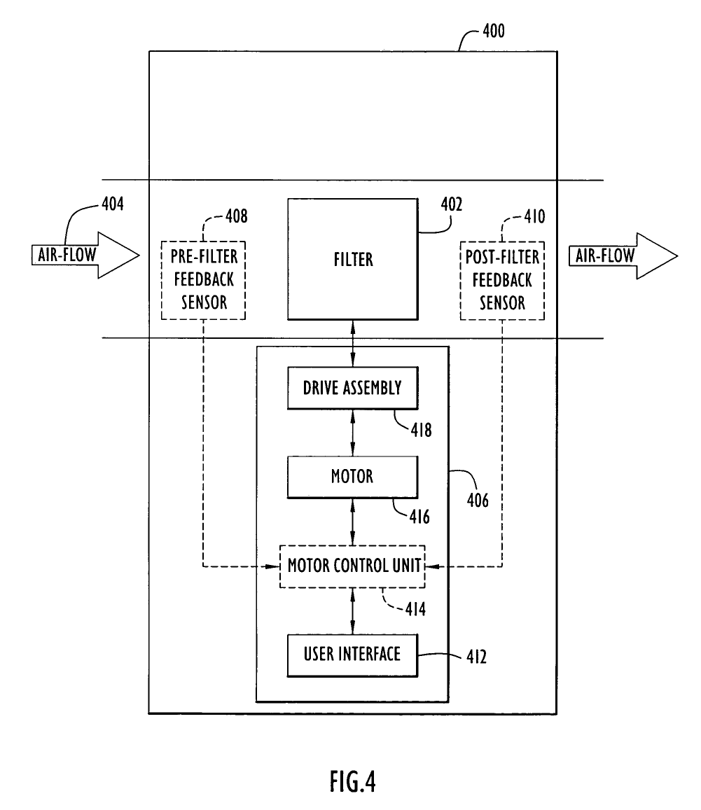

FIG. 4 is a block diagram of a filtration system 400 that uses a filter 402 placed in motion, as described above, to filter an air-flow 404 in accordance with an exemplary embodiment of the present invention. As shown in FIG. 4, filtration system 400 may include a moveable filter 402, a filter motion control module 406, and optional pre-filter feedback sensor 408 and an optional post filter feedback sensor 410 that provide feedback to filter motion control module 406. Filter motion control module 406 may include a user interface 412, an optional motor-control unit, a motor 416, and a drive assembly 418. Filter 402 is placed in motion by filter motion control module 406 in response to operator input received via user interface 412 and optional pre-filter feedback sensor 408 and optional post-filter feedback sensor 410.

User interface 412 presents an operator with input devices that may be used to control motion of filter 402 within air-flow 404. In an embodiment that includes only manual controls, user interface 412 may include an on-off switch, a motor speed control switch, an electronic or mechanical timer to allow a user to set the filter in motion for a specific period of time and/or a programmable timer that allows the filter to be placed in motion in accordance with a pre-programmed schedule. In such an embodiment, user interface 412 may directly control the speed and/or direction of motor 416 which in turn imparts mechanical motion to drive assembly 418 that drives movement of filter 402. Depending upon the nature of filter 402 (e.g., as described above with respect to FIG. 1-FIG. 3) drive assembly 418 may include any combination of drive shafts, gears, belts and/or pulleys required to convey mechanical power from motor 416 to filter 402 and to move filter 402 as described above with respect to FIG. 1-FIG. 3.

Feedback sensors 408 and 410 may include any number of physical sensors used to assess the status and/or performance of filter 402. In an embodiment that includes such feedback sensors, user interface 412 may be used by an operator to input filter performance criteria which are provided to optional motor-control unit 414 to control the motor in accordance with the performance feedback received from one or more of pre-filter feedback sensor 408 and post-filter feedback sensor 410.

A drop in pressure across filter 402 may vary in response to the speed at which the filter is placed in motion, the face velocity of the air-flow against the filter, and the degree of particle buildup upon the filter. To facilitate integration of filtration system 400 within existing duct systems, user interface 412 may be configured to allow an operator to specify an acceptable pressure drop allowed across filter 402. In such an embodiment, motor-control unit 414 may receive an air-flow pressure reading from pre-filter feedback sensor 408 and post-filter feedback sensor 408 and dynamically adjust the speed of motor 416 so that a constant pressure drop and efficiency are maintained as trapped particles buildup on filter 402.

As described above, filtration system 400 moves filter 402 at a high rate of speed relative to the speed of the air-flow passing through the duct. In this manner, the bars and/or mesh of filter 402 may be relatively wide as compared to conventional filters. By placing the filter in motion at high speed relative to air-flow 404, the likelihood of a particle of a specified size impacting filter 402 is increased.

The probability that an individual particle will be impacted by filter 402 increases proportionally with increases in the user specified minimum size of the particles to be impacted, increases proportionally with increases in the thickness of filter 402 and decreases proportionally with increases in the velocity of the air-flow 404 to be filtered. Further, the probability that an individual particle is impacted by filter 402 increases proportionally with increases in the speed of the filter (i.e., the distance the surface areas of the filter move within a unit of time) relative to the distance between impact surfaces (e.g., the edge to edge distance between filter bars/spokes or the average mesh/pore size) of the filter in use. Therefore, as a result of placing filter 402 in motion at a high rate of speed relative to the velocity of the filtered airflow, the probability that the bars and/or mesh of filter 402 will intercept and collect the particulate matter from the air passing through the filter is increased, while the far smaller air molecules continue to pass through filter 402 unimpeded.

In one embodiment of the present invention, user interface 412 may be used by an operator to specify to motor-control unit 414 characteristics related to filter 402, such as the filter type (e.g., rotating cylinder, rotating plane, reciprocating plane), an average distance between filter bars/spokes and/or an average mesh/pore size, a minimum particle size to be filtered, a maximum acceptable pressure drop across filter 402 and/or an efficiency value with which filter 402 is to remove particles at or above the specified minimum size. Such information may be conveyed by user interface 412 to motor-control unit 414 which may use the user specified information, stored tabular information, and/or sensor feedback information (e.g., air-flow velocity, the current pressure drop across the filter, etc.), to determine the speed at which to drive motor 416 in order to achieve the requested level of performance. Further, motor-control unit 414 may dynamically adjust the speed of filter 402 based upon changes in air-flow velocity and/or the pressure drop across the filter to assure that the requested performance criteria are maintained. For example, if the face velocity of air-flow 404 increases by twenty percent, motor-control unit 414 may dynamically increase the speed of filter 402 by twenty percent to compensate for the increased air-flow/particle velocity. If the motor-control unit 414 determines that the requested user performance characteristics cannot be achieved, motor-control unit 414 may generate an alarm condition that is reported to an operator via user interface 412 so that corrective action may be taken, such as cleaning or replacing filter 402.

Motor-control unit 414 may control motor speed in accordance with one or more elements of user input received from user interface 412, feedback received from one or more feedback sensors, and/or information and/or formulas retrieved from tables and/or files to which filter motion control module 406 has access. Stored information may include lookup tables for each type of filter that an installed filtration system is configured to support. By way of example, one such lookup table may allow motor-control unit 414 to determine for a specific filter type a motor speed required to achieve a desired filter speed. By way of second example, another such lookup table may allow motor-control unit 414 to determine a filter speed needed for a specific filter type to filter a specified minimum particle size at a level of efficiency specified by the user based upon a measured filter pressure drop indicating partial particle buildup.

A filter in accordance with the present invention is designed with a low concentration of filter material (e.g., filter fibers, filter elements, filter mesh), relative to the open spaces defined by the filter material through the filter. Further, an average cross-sectional area of defined open spaces through the filter material is typically greater than the average cross-sectional area of the smallest particles to be trapped by the filter. As a result of such a design, if the filter were to remain stationary, an air-flow across the filter would pass virtually unimpeded and few, if any, particles within the air-flow would impact the surface of the mesh of the filter and become trapped. In order for the filter of the present invention to efficiently remove particles from a filtered air-flow, the filter is placed in motion at a high rate of speed relative to the flow of the filtered air-flow so that the filter may make contact with, or impact, particles as they pass through the filter mesh, or pores, suspended within the air-flow. Typically, the higher the coefficient of filter speed to filtered air-flow speed, the more effective the cleaning. Upon impact by the filter, particles within a filtered air-flow may adhere to the filter material, become physically trapped by the filter material and/or be blocked or deflected by the filter into a collection bin, or collection chute, that may be integrated within the filter duct, or filter housing, to receive and collect blocked and/or deflected particles.

For a filter of the present invention to effectively filter particles from an air-flow, the speed of the filter in motion should be sufficiently high so that the filter makes contact with, or impacts, particles of all sizes within the filtered air-flow. In this manner, particles may adhere to a surface of the filter mesh, or pore, (e.g., a bar of a bar filter), become physically trapped by the filter material and/or be blocked or deflected by the filter, as the filtered air-flow passes through the filter. Equation EQ1, below, may be used to approximate a minimum filter speed relative to the speed of a filtered air-flow that assures, with high probability, that contact is established between the filter placed in motion and particles of any size located anywhere within the filtered airflow, thereby allowing particles within the air-flow to be removed with a high level of efficiency regardless of particle size.

$${Rate}_{F} = ( {Rate}_{AF} \times \frac{{Width}_{P}}{{Depth}_{P}} ) . \qquad EQ 1$$

Wherein Rate_{F} is a rate of speed of a slowest surface of the filter when placed in motion; Rate_{AF} is an average rate of speed of the filtered air-flow; Width_{P}, is an average width of a filter pore as measured across the pore in a direction that is parallel with the direction of filter motion; and Depth_{P} is an average depth of a filter pore (e.g., the thickness of a filter bar, the thickness of the filter mesh, etc). EQ1 may be used to determine a minimum speed for a filter placed in motion regardless of the filter shape (e.g., cylindrical, planar, etc.) and type of motion (e.g., rotation, oscillation, etc.) applied to the filter material.

For example, assuming that a cylindrical bar filter, as described with respect to FIG. 1A, with an average distance between bars of 1 cm, an average bar thickness of 2 mm, and a circular base outside circumference of 1 meter, is used to filter an air-flow with a speed of 100 meters per minute. Based upon EQ1, above, the minimum filter speed would be five-hundred meters per minute. Assuming that the circular base circumference of the filter in the current example is one meter, the cylindrical bar filter would need to be rotated at a speed of approximately five-hundred rpm.

In accordance with EQ1, particles of any size will likely come in contact with the filter in motion, regardless of the mesh, or pore, size of the filter, when Rate_{AF} is scaled by the ratio of Width_{P} to Depth_{P}, thereby establishing a minimum rate of speed for the motion of the filter. At this minimum speed, moist and/or sticky particles typically adhere to the filter material upon contact, while harder particles are trapped and/or deflected by the filter material. Given the great variety of particle types and filtered air-flow rates, the speed of the filter set in motion is preferably set to a speed that is two to one-thousand times faster than a minimum speed determined with EQ1. Such a high rate of filter speed relative to the speed of the filtered air-flow assures that impacted particles are likely to at least one of adhere to the filter material, become trapped by the filter material and/or be effectively deflected by the filter material and thus be efficiently removed from the filtered air-flow.

For example, with respect to a rotating plane mesh filter, as described above with respect to FIG. 2B, with a mesh Width_{P} of 1.0 cm and a Depth_{P} of 0.2 cm, rotational filter speeds, between five-thousand and twenty-thousand rpms, with a preferred rotational speed between ten-thousand and fifteen-thousand rpms, have proven effective at removing particles with many different characteristics with respect to size, shape, moisture content, and adhesion characteristics from filtered air-flows with air speeds ranging from one to three-hundred meters per minute.

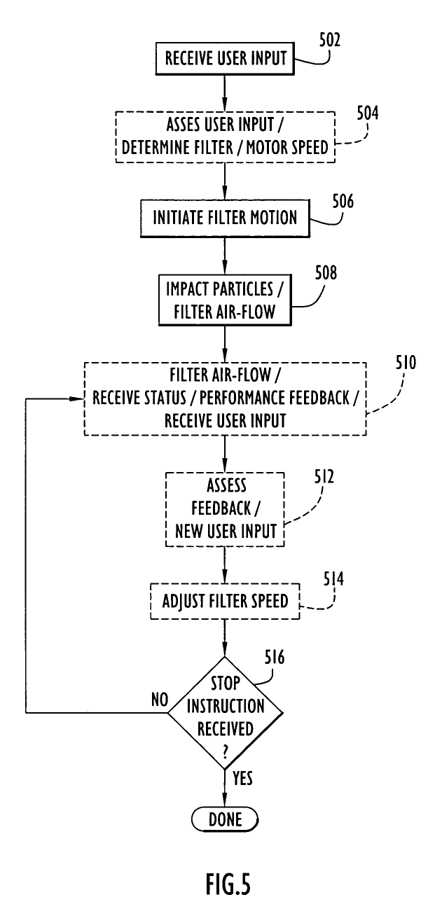

FIG. 5 is a process flow diagram detailing the steps taken by a filtration system of the present invention to filter an air-flow. In accordance with FIG. 5, assuming that the filtration system is operated manually, user input is received, at step 502, via user interface 412 (FIG. 4) and used to place the filter 402 in motion, at step 506, via motor 416 and drive assembly 418 at an operator-selected speed, and/or in accordance with other instructions specified by an operator, manually, via user interface 412. Once in motion at a high rate of speed relative to the speed of the air-flow to be filtered, filter 402 proceeds to impact particles, at step 508, and thereby filter particles from the air-flow. The filtration system proceeds to filter the air-flow in such a manner until an operator instruction is received, at step 516, via user interface 412, instructing the filtration system to cease or change the motion of filter 402.

Further, in accordance with FIG. 5, assuming that the filtration system supports dynamic monitoring and control functions, as described above, user input is received, at step 502, and assessed, at step 504, by motor-control unit 414 (FIG. 4) to determine an appropriate motor speed based upon the operator specified information received, as described above. Motor-control unit 414 initiates, at step 506, filter motion via motor 416 and drive assembly 418 and filter 402 proceeds to impact and remove particles from the filtered air-flow, at step 508. Motor-control unit 414 proceeds to monitor and process, at step 510, user input and filter status/performance feedback information, as described above, which is assessed, at step 512, and used as the basis for dynamically adjusting, at step 514, the speed of filter 402 relative to the filtered air-flow. If a user generated or internally generated instruction to stop is received, at step 516, motion of filter 402 is stopped and the process flow terminates. Otherwise, motor-control unit 414 continues to receive and process user and feedback sensor information and dynamically adjust the speed of filter 402 accordingly.

The filter and filtration system of the present invention allows a filter placed in motion to be automatically cleaned. The type of self-cleaning mechanism used may vary, depending upon the type of filter used and the type of motion employed. For example, in one representative embodiment, the speed of the filter may be temporarily increased in order to shake off the accumulated particle build-up. In another embodiment, a portion of the filter may be cleaned with compressed air, a vacuum, or even a brush, as that portion of the filter emerges from the filtered air stream.

It may be appreciated that the embodiments described above and illustrated in the drawings represent only a few of the many ways of placing a filter in motion at high speed relative to an air-flow in order to impact and remove particles from the air-flow. The present invention is not limited to the specific embodiments disclosed herein, and variations of the method and apparatus described here may be used to filter an air-flow using a filter placed in motion.

The filtration system of the present invention is not limited to any specific implementation or use. For example, the filtration system of the present invention may be implemented as a stand-alone unit that may be placed upon the floor of a room or upon a table to filter air within a room. By way of a second example, the filtration system of the present invention may be integrated within the ductwork of a central air-conditioning/air-purifying system. By way of a third example, the filtration system of the present invention may be integrated within a machine and/or complex industrial process to purify an air-flow prior to releasing the processed air-flow into a surrounding environment.

The drive assembly used to place a filter in motion in accordance with the present invention may use any combination of gears, gear boxes, shafts, flexible shafts, belts and/or pulleys based upon the type of filter used and the location and orientation of the filter relative to the filtration system motor. A filter may receive mechanical energy from the drive assembly via any hub or other strengthened and/or contoured junction that allows the drive assemble to impart sufficient energy to place the filter in motion, as described above.

A filter in accordance with the present invention is not limited to any specific shape, size or type of motion. The present invention may include any filter placed in motion at a high rate of speed relative to the speed of the air-flow to be filtered. Preferably, the filter and the direction of motion of the filter is oriented substantially perpendicular to the filtered air-flow, however, such perpendicular orientation is not required.

A filter in accordance with the present invention may be of any size and shape and may be placed directly within an existing duct or placed within a filter housing suitable for the filter type, filter size, filter shape, type of filter motion and/or type of self-cleaning technique employed by the filtration system in which the filter is used. Use of a filter housing allows the filtration system of the present invention to be adapted for stand-alone use and/or for use with existing ductwork of any size and shape.

A filter in accordance with the present invention is not limited to any specific material or manner of manufacture. For example, web filter material may be woven, cut or stamped from a single sheet or tube of material, or molded. Bar filters may be assembled from multiple components or cast from a single mold using plastics, metal (e.g., aluminum), or any other material.

The filtration system of the present invention is not limited to filtering air, but may be used to filter particles of any size from any gas or combination of gases. Filters used by the filtration system are not limited to any particular mesh size and/or separation between filter spokes and/or filter bars. Further, the filtration system, or filter, of the present invention may remove particles from a filtered air-flow by any means, including adhesion of impacted particles to the filter material, physically trapping impacted particles within the filter material and/or blocking or deflecting impacted particles into a collection bin, or collection chute, that may be integrated within the filter duct, or filter housing, to receive and collect blocked and/or deflected particles.

Nothing in this disclosure should be interpreted as limiting the present invention to any specific feedback sensor technology. Feedback sensors may include any number and/or combination sensors of any type and may include, but are not limited to, pressure sensors to measure a pressure drop across a filter, light sensors to measure the transmission of light through a filter in motion to assess the cleanliness of the filter, particle sensors to sample particles in an air-flow on one or more sides of a filter, air-flow sensors to detect the air-flow speed on one or more sides of a filter, and/or any other type of sensor that may used to assess the performance of a filter and/or the environment in which the filter is operating.

Nothing in this disclosure should be interpreted as requiring any specific manner of representing stored relationships between filter types, filter mesh size, filter bar separation, measured pressure drops across a filter, filter speed and/or filtration system motor speed required to remove particles of a specified size from an air-flow with a known velocity. It is to be understood that the filtration system may include commercially available components tailored in any manner to implement functions performed by the filtration system described here. Control parameters and/or stored relationships between control parameters and/or measured sensor feedback may be stored in any quantity and any type of data files or other structures (e.g., ASCII, binary, plain text, etc.).

A user interface of the present invention may include any number of buttons, switches, dials, LCD displays and/or any other user input device that may be used to specify instructions and/or performance criteria for use in controlling operation of a filtration system in accordance with the present invention.

The filtration system described here can be implemented in any number of units, or modules, and is not limited to any specific hardware and/or software module architecture. Each module can be implemented in any number of ways and are not limited in implementation to execute process flows precisely as described above. The filtration system described above and illustrated in the flow charts and diagrams may be modified in any manner that accomplishes the functions described herein. It is to be understood that various functions of the filtration system may be distributed in any manner among any quantity (e.g., one or more) of hardware and/or software modules or units, computer or processing systems or circuitry.

A filtration system in accordance with the present invention may include multiple filters arranged in series and/or in parallel to form a bank of filters. Use of multiple filters in series allows each filter to be configured to remove particles within a specific size range, thereby improving the efficiency and/or achieving a higher level of purity than can be achieved with a single filter. Use of multiple filters in parallel allows multiple filters to filter portions of an air-flow simultaneously, thereby increasing overall air-flow throughout with reduced overall backpressure.

From the foregoing description it may be appreciated that the present invention includes a method and apparatus for filtering an air-flow using a filter that is placed in motion at high speed relative to the filtered air-flow.

Having described preferred embodiments of a method and apparatus for filtering particulate matter, it is believed that other modifications, variations and changes may be suggested to those skilled in the art in view of the teachings set forth herein. It is therefore to be understood that all such variations, modifications and changes are believed to fall within the scope of the present invention as defined by the appended claims.

1. A method for filtering a gas-flow, the method comprising:
(a) receiving the gas-flow through at least one of a duct and a housing containing a filter;
(b) placing the filter in motion; and
(c) impacting particulate matter suspended within the gas-flow with the filter, as a result of placing the filter in motion;
wherein upon impact the particulate matter is removed from the gas-flow.

2. The method of claim 1, wherein upon impact the particulate matter adheres to the filter and is thereby removed from the gas-flow.

3. The method of claim 1, wherein upon impact the particulate matter is physically trapped within the filter and is thereby removed from the gas-flow.

4. The method of claim 1, wherein upon impact the particulate matter is deflected from a direction of motion of the gas-flow and is thereby removed from the gas-flow.

5. The method of claim 1, wherein (b) further includes:
(b.1) placing the filter in one of a rotational motion and an oscillating motion.

6. The method of claim 1, wherein (b) further includes:
(b.1) placing the filter in motion in a direction substantially perpendicular to a direction of motion of the gas-flow.

7. The method of claim 1, wherein (b) further includes:
(b.1) placing the filter in motion at a rate of speed that is at least one of equal to and greater than a speed of the filtered air-flow scaled by a ratio of a filter pore average width to a filter pore average depth.

8. The method of claim 1, wherein (b) further includes:
(b.1) placing the filter in motion at a speed that is two to one-thousand times greater than a speed of the filtered air-flow scaled by a ratio of a filter pore average width to a filter pore average depth.

9. The method of claim 1, further comprising:
(d) receiving feedback related to at least one of an operational performance and an operational condition of the filter.

10. The method of claim 9, wherein the received feedback includes at least one of:
a measure of a pressure of the gas-flow before passing through the filter;
a measure of a pressure of the gas-flow after passing through the filter;
a measure of a pressure differential across the filter;
a measure of a particle buildup within the filter;
a measure of a speed of the filter;
a measure of a speed of the gas-flow;
a measure of at least one of a number of particles and a size of particles in the air-flow before passing through the filter; and
a measure of at least one of a number of particles and a size of particles in the air-flow after passing through the filter.

11. The method of claim 9, further comprising:
(e) adjusting a speed of the filter in response to the received feedback.

12. The method of claim 11, wherein (e) further includes:
(e.1) assessing the received feedback to determine whether to at least one of increase the filter speed and decrease the filter speed in response to the received feedback.

13. The method of claim 11, wherein (e) further includes:
(e.1) adjusting the speed of the filter to sustain a user specified performance criteria.

14. The method of claim 13, wherein the user specified performance criteria is at least one of:
a user specified pressure drop across the filter; and
a user specified efficiency in trapping particles of a user specified minimum size.

15. An apparatus for filtering a gas-flow, the apparatus comprising:
a housing to receive a gas-flow and to convey the gas-flow in a direction of motion through the housing;
a filter positioned within the housing;
a filter-motion-control module to place the filter in motion, said filter-motion-control module further comprising:
a motor to create mechanical energy in accordance with operator input received from the user interface; and
a drive-assembly module, connected between the motor and the filter to convey mechanical energy from the motor to the filter;
wherein the filter impacts particulate matter suspended within the gas-flow as a result of the filter motion and thereby removes the particulate matter from the gas-flow.

16. The apparatus of claim 15, wherein upon impact the particulate matter adheres to the filter and is thereby removed from the gas-flow.

17. The apparatus of claim 15, wherein upon impact the particulate matter is physically trapped within the filter and is thereby removed from the gas-flow.

18. The apparatus of claim 15, wherein upon impact the particulate matter is deflected from a direction of motion of the gas-flow and is thereby removed from the gas-flow.

19. The apparatus of claim 15, wherein the filter-motion-control module further comprises:
a user-interface module to receive input from an operator.

20. The apparatus of claim 15, wherein the filter-motion-control module further comprises:
a speed-control module to control the speed of the filter motion.

21. The apparatus of claim 20, wherein the speed-control module is configured to place the filter in motion at a rate of speed that is at least one of equal to and greater than a speed of the filtered air-flow scaled by a ratio of a filter pore average width to a filter pore average depth.

22. The apparatus of claim 20, wherein the speed-control module is configured to place the filter in motion at a speed that is two to one-thousand times greater than a speed of the filtered air-flow scaled by a ratio of a filter pore average width to a filter pore average depth.

23. The apparatus of claim 15, wherein the filter-motion-control module is configured to place the filter in one of a rotational motion and an oscillating motion.

24. The apparatus of claim 15, wherein the filter-motion-control module is configured to place the filter in a direction of motion substantially perpendicular to the direction of motion of the gas-flow through the housing.

25. The apparatus of claim 19, wherein the filter-motion-control module further comprises:
a motor-control unit to receive input from an operator via the user-interface module and to control the motor in accordance with said received input.

26. The apparatus of claim 25, wherein the filter-motion-control module further comprises:
a feedback sensor to send information related to at least one of a filter operational condition and a filter level of performance to the motor-control unit.

27. The apparatus of claim 26, wherein the motor-control unit further includes a feedback reception module to receive feedback sensor information related to at least one of:
a pressure of the gas-flow before passing through the filter;
a pressure of the gas-flow after passing through the filter;
a pressure differential across the filter;
a particle buildup within the filter;
a speed of the filter;
a speed of the gas-flow;
at least one of a number of particles and a size of particles in the air-flow before passing through the filter; and
at least one of a number of particles and a size of particles in the airflow after passing through the filter.

28. The apparatus of claim 26, wherein the motor-control unit further comprises:
a motor-speed-adjustment module to adjust the speed of the filter in response to the received feedback.

29. The apparatus of claim 15, wherein the motor-speed-adjustment module further comprises:
a performance module to determine whether to at least one of increase the motor speed and decrease the motor speed in order to sustain a performance criteria received via the user interface module.

30. The apparatus of claim 19, wherein the performance criteria is at least one of:
a user specified pressure drop across the filter; and
a user specified efficiency in trapping particles of a user specified minimum size.

31. A filter for filtering a gas-flow, comprising:
a filter material having a plurality of open spaces defined within, wherein an average cross-sectional area of the plurality of defined open spaces is greater than an average cross-sectional area of a smallest particle the filter is configured to remove from the gas-flow; and
a means for receiving mechanical energy to place the filter material in motion.

32. The filter of claim 31, wherein the filter material is configured as a hollow cylinder configured to rotate about a longitudinal center axis of the hollow cylinder.

33. The filter of claim 31, wherein the filter material is configured into a sheet with a substantially planar surface and configured to rotate about a center axis perpendicular to the planar surface of the filter material.

34. The filter of claim 31, wherein the filter material is planar and configured to oscillate within a plane.

35. The filter of claim 31, wherein the filter material includes at least one of a grid, a mesh and a plurality of bars.

36. The filter of claim 31, wherein the means for receiving mechanical energy is a hub centered upon a center axis of the filter material.

37. The filter of claim 31, wherein the means for receiving mechanical energy is located upon a perimeter of the filter material.

38. The filter of claim 31, wherein the means for receiving mechanical energy is configured to receive mechanical energy from a drive module to place the filter material in one of a rotational motion and an oscillating motion.

39. The filter of claim 31, wherein the means for receiving mechanical energy is configured to receive mechanical energy from a drive module to place the filter material in one of a rotational motion and an oscillating motion that is substantially perpendicular to a direction of motion of the filtered air-flow.

40. The filter of claim 31, wherein the means for receiving mechanical energy is configured to place the filter in motion in a direction substantially perpendicular to a direction of motion of the filtered gas-flow.
